(19) United States
(12) Patent Application Publication
(10) Pub. No.: US 2026/0289292 A1
(43) Pub. Date: Sep. 24, 2026

(54) IN-CONTEXT LEARNING OF TABULAR DATA SCALED TO LARGE DATASETS

(71) Applicant: SAP SE, Walldorf (DE)

(72) Inventors: Stefan Klaus Baur, Heidelberg (DE); Sohyeong Kim, Berlin (DE)

(21) Appl. No.: 19/083,879

(22) Filed: Mar. 19, 2025

(51) Int. Cl. G06N 3/08; G06N 3/0455

(52) U.S. Cl. CPC G06N 3/08; G06N 3/0455

(57) ABSTRACT

In an example embodiment, an in-context model is trained on synthetic datasets using an auto-regressive approach in lieu of a transformer approach. This allows replacing the backbone of the model with an auto-regressive architecture. The trained auto-regressive model is then capable of in-context predictions on tabular data. An in-context model leverages the immediate information provided to it during an interaction or session to generate predictions or responses, dynamically adjusting to the task or context at hand. An auto-regressive model is a type of model that generates predictions or outputs sequentially, where each output is conditioned on the previous outputs. It generates a new token (or piece of data) based on the data it has already produced, rather than looking at all the data at once. The trained in-context auto-regressive model is able to process tabular data more efficiently than a transformer model would.

### TECHNICAL FIELD

This document generally relates to computer systems. More specifically, this document relates to in-context learning of tabular data scaled to large datasets.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a diagram illustrating a Tabular Prior-Data Fitted Network-based (TabPFN-based) foundation model.

FIG. 2 is a diagram illustrating training an auto-regressive foundation model, in accordance with an example embodiment.

FIG. 3 is a diagram illustrating using the auto-regressive foundation model for prediction based on test data or a query, in accordance with an example embodiment.

FIG. 4 is a block diagram illustrating an auto-regressive foundation model in the form of a structured state space model.

FIG. 5 is a block diagram illustrating an auto-regressive foundation model in the form of hybrid transformer/structured state space model.

FIG. 6 is a flow diagram illustrating a method for training an in-context machine learning model to predict target values on tabular data, in accordance with an example embodiment.

FIG. 7 is a flow diagram illustrating a method for making predictions of target values in tabular data, in accordance with an example embodiment.

FIG. 8 is a block diagram illustrating an architecture of software for embedding searches, which can be installed on any one or more devices.

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

LLMs typically utilize a transformer architecture (described in more detail below) to generate predicted output. While this approach works well for unstructured data, such as text, there are technical issues that impede their ability to efficiently process tabular data. Tabular data is highly structured in that the data is stored in the form of tables, such as database tables. Each table comprises at least two columns and at least one row. In some instances, it is desirable to predict values for cells in such tables using the values in other cells. This could be useful in forecasting future values for given data or even just filling in cells that, for one reason or another, are missing values (such as from a data entry error).

More specifically, using transformer-based models to predict values in tabular data using in-context learning is limited by the quadratic time complexity and memory consumption (as a function of dataset size or context length) of transformer models, due to a concept called “self-attention”. Self-attention is a mechanism that allows the model to weigh the importance of different words (or tokens) in a sequence relative to each other when processing or generating text. It is a way for the model to determine how much attention each word should pay to all other words in a sentence, which helps capture relationships between distant words.

Self-attention, however, causes a dramatic increase in quadratic time complexity of a model because it computes pairwise interactions between all tokens in an input sequence. Specifically, for each word or token in a sequence, the model computes attention scores with every other word or token in the sequence. Additionally, once the context has been processed, then during inference the entire context has to be scanned to produce a prediction on an unseen example. Both of these issues are dramatically increased when dealing with tabular data, making transformer-based models inefficient when tabular data is processed as context. When predicting with a transformer on individual records (zero-shot), this may not be much of an issue, but it is an issue for in-context-based (many-shot) predictions.

One approach for implementing a transformer-based model for processing tabular data is known as a Tabular Prior-Data Fitted Network (TabPFN). The core idea behind TabPFN is to use a pretraining approach, similar to how models like Generative Pre-trained Transformer (GPT) or Bidirectional Encoder Representations from Transformers (BERT) work for text. During the pretraining phase, the model learns patterns, relationships, and feature representations from a wide variety of tabular datasets, including synthetic data sets. This allows it to capture useful knowledge that can be transferred to new tasks, even with smaller datasets.

Once pretrained, the model can be applied to a specific dataset via in-context learning for a particular task, such as classification or regression. This process adapts the learned features to the new task, making the model more effective and efficient, even when there is limited data available. Alternatively, the model could be further adapted by fine-tuning on specific dataset and task.

Because TabPFN learns feature transformations during pretraining, it can process data in a way that's more flexible and powerful than traditional machine learning models, which often require manual feature extraction. It can be applied to a variety of problems involving tabular data, such as predicting sales, diagnosing medical conditions, or any task requiring structured data. However, like other transformer-based models, TabPFN can be computationally expensive to train, specifically with tabular data.

In an example embodiment, an in-context model is trained on synthetic datasets using an auto-regressive approach in lieu of a transformer approach. This allows replacing the backbone of the model with an auto-regressive architecture. The trained auto-regressive model is then capable of in-context predictions on tabular data. An in-context model leverages the immediate information provided to it during an interaction or session to generate predictions or responses, dynamically adjusting to the task or context at hand. An auto-regressive model is a type of model that generates predictions or outputs sequentially, where each output is conditioned on the previous outputs. It generates a new token (or piece of data) based on the data it has already produced, rather than looking at all the data at once. The trained in-context auto-regressive model is able to process tabular data more efficiently than a transformer model would.

It should be noted that it is also possible to train on real-data for the pre-training, but this eliminates the advantage of synthetic data in that with synthetic data there is no risk of data leakage, such as by evaluating the model on data that was also part of the pre-training.

As mentioned briefly before, TabPFN is a transformer-based foundation model approach for in-context learning on tabular data. Synthetic data is used to train a transformer backbone to produce a foundation model. At inference time, training data and query samples are fed into the foundation model in a single forward pass. The training data is considered the context, and the query samples (or test data) is fed with it in that single forward pass. The transformer architecture, however, limits both the maximum sequence length of training data and inference speed, due to quadratic computational complexity.

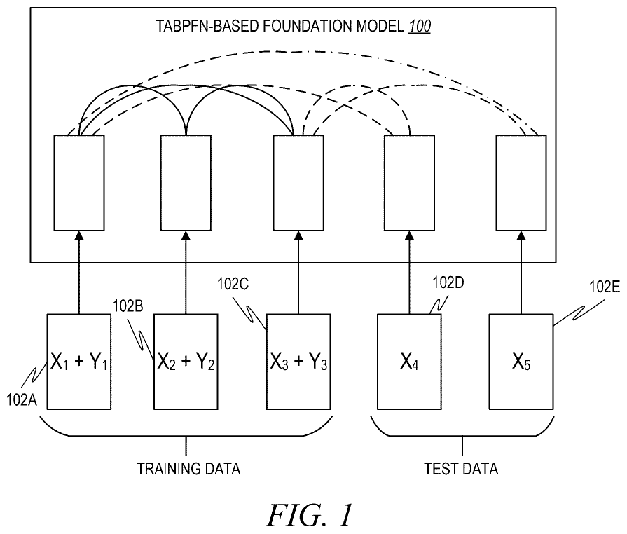

FIG. 1 is a diagram illustrating a TabPFN-based foundation model 100. Here, training data 102A, 102B, 102C is combined with test data 102D, 102E and fed to the TabPFN-based foundation model 100 in a single forward pass. The TabPFN-based foundation model 100 then computes pairwise interactions via multi-head self-attention between each pair of input data 102A, 102B, 102C, 102D, 102E. Here, the solid lines represent the interactions among pairs of training data 102A, 102B, 102C while the dashed lines represent the interactions among pairs of test data 102D, 102E and training data 102A, 102B, 102C. Each piece of training data 102A, 102B, 102C may include feature data (represented by x) and target data (represented by y). The target data is the data the TabPFN-based foundation model 100 is trained to predict. The test data 102D, 102E (which could also be query samples, i.e., inference-time data) lacks such target data and thus will need it predicted.

Furthermore, the result of feeding the test data 102D, 102E into the TabPFN-based foundation model 100 is a set of probability distributions over values of Y. These probability distributions can then be compared to “ground truth” values of Y from the synthetic dataset, via a cross-entropy loss giving the signal for optimizing/updating the model weights.

In the TabPFN framework, synthetic training data is created using probabilistic modeling and data augmentation techniques. The model leverages probabilistic approaches to generate new data by sampling from learned distributions based on the real dataset. This process often involves conditional probability distributions that are derived from the features and outcomes in the original data. Additionally, Bayesian inference might be employed to model the uncertainty in the data generation, ensuring that the synthetic data is realistic and aligned with the true data distribution while introducing some variations.

To enhance the data, TabPFN also applies data augmentation methods, such as perturbing the features of the original data by making small random changes. This can involve slightly altering numerical values or modifying categorical features, ensuring the changes are still plausible. Another common technique is adding noise to the original data, which helps create variations that improve the robustness of the model. In some cases, generative models like GANs (Generative Adversarial Networks) or VAEs (Variational Autoencoders) might be used, allowing the model to generate synthetic data that closely mimics the real data's distribution.

In an example embodiment, the synthetic training data generated using the approach described in TabPFN may be utilized with an auto-regressive approach rather than an encoder transformer-based approach to training. In other words, the synthetic training data of TabPFN may be used, but not the model architecture of TabPFN. The TabPFN transformer model itself is not used for training data generation, but rather the dataset is generated synthetically (by a set of rules-based functions described later), but its purpose is to be used as the pre-training dataset to enable in-context learning in the model resulting from this training. Thus, the same training dataset as TabPFN can be used, but a different modeling of inputs may be used as well as a different backbone architecture.

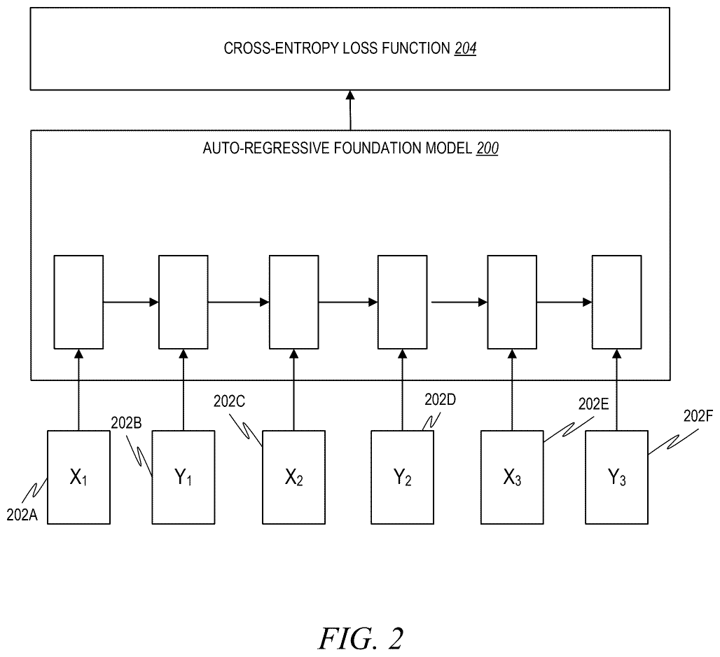

FIG. 2 is a diagram illustrating training an auto-regressive foundation model 200, in accordance with an example embodiment. Here, each piece of training data 202A, 202B, 202C, 202D, 202E, 202F is using sequentially to train the auto-regressive foundation model 200. A cross-entropy loss function 204 may be used to evaluate the training. Cross-entropy loss measures the difference between two probability distributions—the true distribution (the actual labels) and the predicted distribution (the model's output). It essentially quantifies how well the model's predictions match the true labels and generates the signal for updating the model weights using a suitable optimizer, such as AdamW.

The cross-entropy loss encourages the model to output probabilities close to 1 for the correct class and close to 0 for the incorrect classes. If the model's predicted probabilities are very different from the true labels, the loss will be large. On the other hand, if the predictions are close to the true values, the loss will be smaller, guiding the model toward better performance.

The sequential training applies to each piece of training data 202A, 202 B, 202C, 202D, 202E, 202F. Thus, for example training data 202B is fed subsequently to training data 202A, with training data 202A representing feature data and training data 202B representing target data. Following training data 202B, training data 202C is fed. Since the auto-regressive foundation model 200 is auto-regressive, each prediction is based on the earlier data.

A cross-entropy loss function 204 may be used to evaluate the training. Cross-entropy loss measures the difference between two probability distributions—the true distribution (the actual labels) and the predicted distribution (the model's output). It essentially quantifies how well the model's predictions match the true labels. Here, the cross-entropy loss sits on the outputs of the x's, where the model predicts the value of the target y_pred.

The training data 202A, 202C, 202D, 202E, 202F may be sampled as described in more detail below, and may comprise N sampled feature-target pairs (xᵢ, yᵢ)^{N}ᵢ₌₁ with D features and T target classes. While the synthetic training dataset must be explicitly split into training and test data if used in a specialized encoder-decoder transformer-based approach as in TabPFN, almost all feature-target pairs of each dataset can be used for training in an auto-regressive approach since the auto-regressive (causal) model conditions output only on the previous input. This is accomplished by using a specific “causal attention mask” to restrict the attention to current and past inputs. This enables more efficient use of the pre-training dataset.

The auto-regressive model maps a sequence of feature-target pairs

$$( xi , yi ) \begin{matrix}k - 1 \\ i = 1\end{matrix}$$

and a query item xₖ to a probability distribution over predicted target classes

$${q}_{θ} ( {y}_{k} = ( x , y ) \begin{matrix}i = k - 1 \\ i = 1\end{matrix} , {x}_{k} )$$

parametrized by the model weights θ.

Each feature vector xᵢ is embedded into the input space of the auto-regressive backbone architecture using a linear layer and the target class yᵢ is encoded using a one-hot linear layer.

The model may be trained using cross-entropy loss summed over all samples in the training dataset, excluding the first k₀=50 samples to have high probability that all 10 possible target classes have appeared at least once in the initial context

$$ℒ ∝ - {\sum }_{k = {k}_{0} + 1}^{N} {\sum }_{c = 1}^{C} {y}_{k , c} log {q}_{θ} ( {y}_{k} = c \vert ( x , y ) \begin{matrix}k - 1 \\ i = 1\end{matrix} , {x}_{k} ) .$$

The generation and sampling of the synthetic training data may be described in more detail as follows:

The Posterior Predictive Distribution for Supervised Learning—In the Bayesian framework for supervised learning, the prior defines a space of hypotheses Φ on the relationship of a set of inputs x to the output labels y. Each hypotheses φϵΦ can be seen as a mechanism that generates a data distribution from which samples can be drawn forming a dataset. For example, given a prior based on structural causal models, Φ is the space of structural causal models, a hypothesis φ is one specific SCM, and a dataset comprises samples generated through this SCM. In practice, a dataset comprises training data with observed labels and test data where labels and test data where labels are missing or held out to assess predictive performance. The PPD for a test sample xₜₑₛₜ specifies the distribution of its label p(⋅|xₜₑₛₜ, Dₜᵣₐᵢₙ), which is conditioned on the set of training sample Dₜᵣₐᵢₙ:={(x₁, y₁), . . . , (xₙ, yₙ)}. The PPD can be obtained by integration over the space of hypotheses Φ, where the weight of a hypothesis φϵΦ is determined by its prior probability p(φ) and the likelihood p(D|φ) of the data D given φ:

$$p ( y \vert x , D ) ∝ {\int }_{Φ} p ( y \vert x , ϕ ) p ( D \vert ϕ ) p ( ϕ ) d ϕ .$$

Synthetic Prior-fitting-Prior-fitting is the training of a PFN to approximate the PPD and thus do Bayesian prediction. It may be implemented with a prior which is specified by a prior sampling scheme of the form p(D)=|E_{φ~p(φ)}[p(D|φ)], which first samples hypotheses (generating mechanisms) with φ~p(φ) and then synthetic datasets with D~p(D|φ). Such synthetic datasets D:=(xᵢ, yᵢ)_{i∈{1, . . . , n}} may be repeatedly samples and the PFN's parameters θ may be optimized to make predictions for Dₜₑₛₜ⊂D, conditioned on the rest of the dataset Dₜᵣₐᵢₙ=D\Dₜₑₛₜ. The loss of PFN training thus is the cross-entropy on held-out examples of synthetic datasets. For a single test point {xₜₑₛₜ, yₜₑₛₜ)}=D, the training loss can be written as

$${ℒ}_{PFN} = {𝔼}_{( \{ ( {x}_{test} - {y}_{test} ) \} ⊔ {D}_{train} ) ∼ p ( D )} [ log {q}_{θ} ( {y}_{test} \vert {x}_{test} , {D}_{train} ) ]$$

During inference, the entire training dataset may be fed dataset as context into the model and then, for the query (test) items xₖ, the target classes

$$y \begin{matrix}pred \\ k\end{matrix} ,$$

are predicted.

In order to avoid reprocessing the context for each query item on which a prediction should be made, in an example embodiment a caching functionality may be used.

More specifically, because the model is auto-regressive, inference happens as follows:

Given a training dataset (x_1, y_1, x_2, y_2, . . . , x_N, y_N) and a set of M queries, one wants to predict on (x_{N+1}, . . . , x_{N+M}), one first processes the context and then predicts on each point separately:

$$Prediction ( y\_ \{ N + 1 \} ) = f ( x\_ 1 , y\_ 1 , x\_ 2 , y\_ 2 , … , x\_N , y\_N , x\_ \{ N + 1 \} )$$

$$Prediction ( y\_ \{ N + 2 \} ) = f ( x\_ 1 , y\_ 1 , x\_ 2 , y\_ 2 , … , x\_N , y\_N , x\_ \{ N + 2 \} )$$

$${…}^{′}$$

$$Prediction ( y\_ \{ N + M \} ) = f ( x\_ 1 , y\_ 1 , x\_ 2 , y\_ 2 , … , x\_N , y\_N , x\_ \{ N + M \} ) ,$$

Where f here represents the model.

Without caching, each prediction would require processing the entire context (for transformers due to attention this would be O[N\hat{ }2] time complexity and for state space models [SSMs]/recurrent neural networks [RNNs] this would be O[N] time complexity).

With key, value (=K,V), caching a set of tensors that do not have to be reprocessed for each prediction on a newly appended transformer input, the predictions for each query x just requires O(N) instead of O(N\hat{ }2) time complexity. Likewise, for the SSMs (or RNNs), the final hidden states (independent of the length of the sequence, so constant size) could be cached and the predicting on a single query item would require only constant time O(1) instead of O(N) if the entire sequence would be processed for each prediction.

This would be in contrast to, for example, processing the context and all the query or test points together using a specially designed attention mask (where the query/test inputs just attend to the training samples and not to each other). This is at least as efficient as the K, V caching if all data points that one wants to predict on is known, but in practical applications where the model would be served and data to predict on comes in chunks, this might not be ideal as the predictions would always have the O(N\hat{ }2) time complexity for each prediction (where N is size/number of rows of the training set).

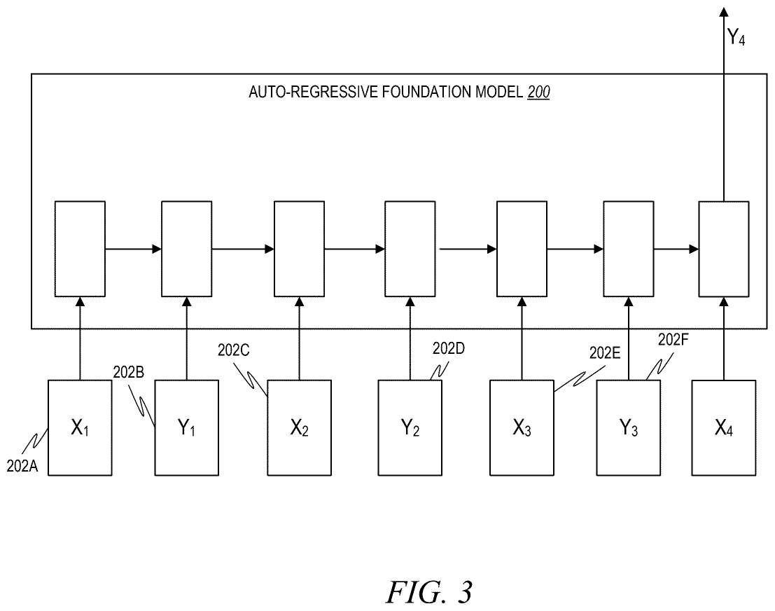

FIG. 3 is a diagram illustrating using the auto-regressive tabular foundation model 200 for prediction based on test data or a query, in accordance with an example embodiment. Here, each piece of training data 202A, 202B, 202C, 202D, 202E, 202F is using sequentially to train the auto-regressive foundation model 200.

Implementation of the auto-regressive techniques described herein can be accomplished in a number of ways. In one example embodiment, the auto-regressive foundation model 200 is a structured state-space model. In another example embodiment, the auto-regressive foundation model 200 is a hybrid of a state-space model and a transformer architecture.

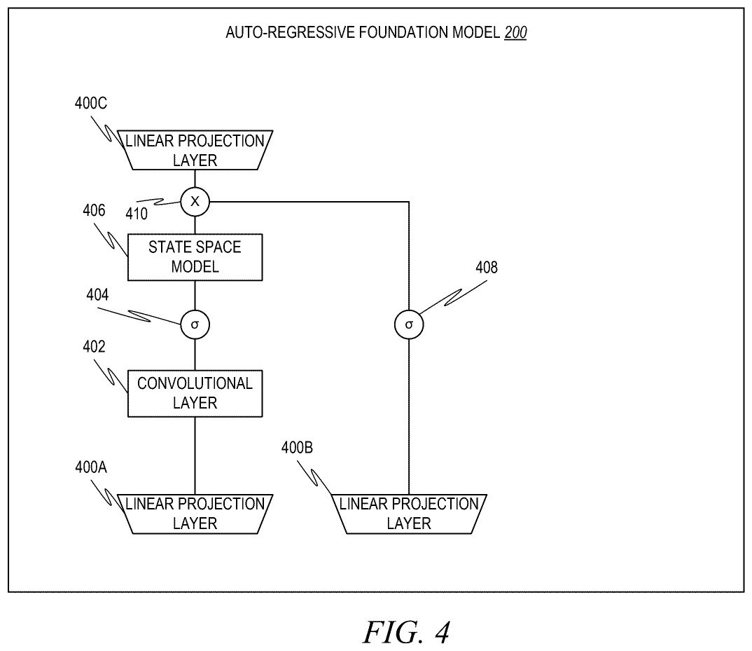

FIG. 4 is a block diagram illustrating an auto-regressive foundation model 200 in the form of a structured state space model. A structured state space model is a combination of a recurrent neural network and a convolutional neural network, with inspiration from classical state space models. They map a 1-dimensional function or sequence x(t)ϵ [symbol] y(t)∈ [symbol] through an implicit latent state h(t)∈ [symbol] .

Concretely, S4 models are defined with four parameters (Δ, A, B, C), which define a sequence-to-sequence transformation in two stages.

| | | |
|---|---|---|
| h′(t) = Ah(t) + Bx(t) (1a) | hₜ = Āhₜ₋₁ + B̅xₜ (2a) | K̅ = (CB̅, CA̅B̅, . . . , Ā^{k}B̅, . . . ) |
| y(t) = Ch(t) (1b) | yₜ = Chₜ (2b) | y = x * K̅ |

Discretization. The first stage transforms “continuous parameters” (Δ, A, B) to “discrete parameters” (Ā,B̅) through fixed formulas Ā=f_{A}(Δ, A) and B̅=f_{B}(Δ, A, B), where the pair (f_{A}, f_{B}) is called a discretization rule. Various rules can be used such as the zero-order hold (ZOH) defined in equation (4).

$$\overline{A} = exp ( DA ) \qquad \overline{B} = {( Δ A )}^{- 1} ( exp ( DA ) - I ) \cdot Δ B$$

Discretization has deep connections to continuous-time systems which can endow them with additional properties such as resolution invariance and automatically ensuring that the model is properly normalized. It also has connections to gating mechanisms of RNNs. However, from a mechanical point of view discretization can simply be viewed as the first step of the computation graph in the forward pass of an SSM. Alternate flavors of SSMs can bypass the discretization step and parameterize (Ā,B̅) directly instead, which may be easier to reason about.

Computation. After the parameters have been transformed from (Δ. A, B, C) [symbol] (Ā, B̅, C), the model can be computed in two ways, either as a linear recurrence (2) or a global convolution (3).

Commonly, the model uses the convolutional mode (3) for efficient parallelizable training (where the whole input sequence is seen ahead of time) and switched into recurrent mode (2) for efficient autoregressive inference (wherein the inputs are seen one time stop at a time).

Linear Time Invariance (LTI). The model's dynamics are constant through time. In other words (Δ. A, B, C), and consequently (Ā,B̅) as well, are fixed for all time-steps. This property is called linear time invariance (LTI), which is deeply connected to recurrence and convolutions. Informally, LTI SSMs may be thought of as being equivalent to any linear recurrence or convolution and use LTI as an umbrella term for these classes of models.

Structures and Dimensions. Structured SSMs are so named because computing them efficiently also requires imposing structure on the A matrix. The most popular form of structure is diagonal.

In this case, the Aϵ [symbol] , Bϵ [symbol] , C∈ [symbol] matrices can all be represented by N numbers. To operate over an input sequence x of batch size B and length L with D channels, the SSM is applied independently to each channel. Note that in this case the total hidden state has dimension DN per input and computing it over the sequence length requires O(BLDN) time and memory: this is the root of the fundamental efficiency bottleneck.

General State Space Models. The term state space model has a very broad meaning which simply represents the notion of any recurrent process with a latent state. It has been used to refer to many disparate contents in different modeling (DCM) (computational neuroscience), Kalman filters (controls), hidden Markov models (HMM) and linear dynamical systems (LDS) (machine learning), and recurrent (and sometimes convolutional models) at large (deep learning).

SSM Architectures. SSMs are standalone sequence transformations that can be incorporated into end-to-end neural network architectures. (SSM architectures are also sometimes called SSNNs, which are to SSM layers as CNNS are to linear convolutions layers.)

More specifically, the auto-regressive foundation model 200 comprises multiple linear projection layers 400A, 400B, 400C. A convolutional layer 402 connects to linear projection layer 400A and then to a first activation the linear function 404. A state space model 406 then connects to the first activation function 404. A second activation function 408 connects to the second linear projection layer 400B, and a multiplication function 410 connects to the output of the state space model 406 and the second activation function 408. The third linear projection layer 400C then obtains the product produced by the multiplication function 410.

It should be noted that in FIG. 4 a single layer is shown, in practice there may be a number of layers, such as twelve to twenty four layers, stacked.

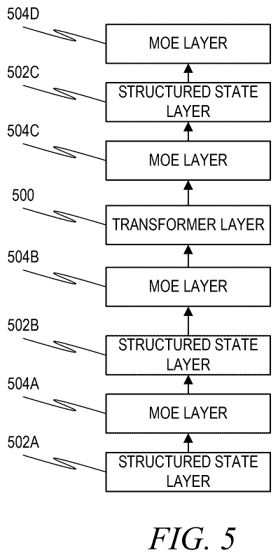

FIG. 5 is a block diagram illustrating an auto-regressive foundation model 200 in the form of hybrid transformer/structured state space model. This hybrid architecture involves mixing a transformer layer 500, state space layers 502A, 502B, 502C, and mixture of experts (MoE) layers 504A, 504B, 504C, 504D.

Each MOE layer leverages a mixture of specialized sub-networks (called “experts”) and routing mechanisms to determine which experts should be activated for a given input.

It should be noted that in addition to a state space model or a hybrid model, embodiments are possible where a transformer architecture is utilized, albeit used in a manner to make the training of the transformer architecture be performed auto-regressively, which is contrast to how in-context learning transformer architectures were trained in the past.

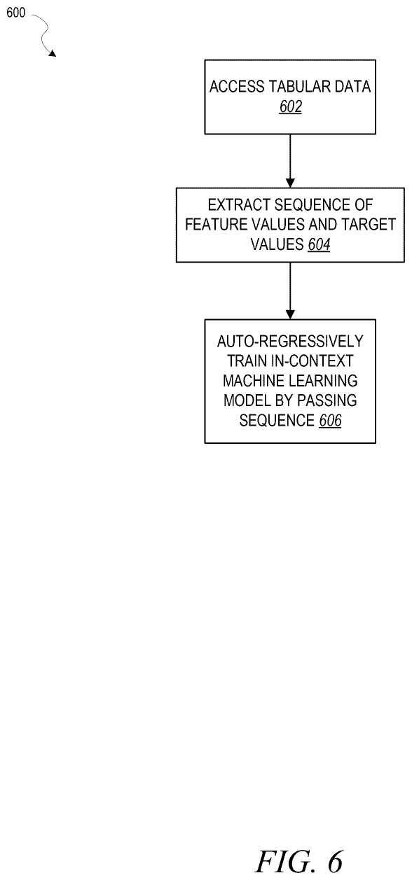

FIG. 6 is a flow diagram illustrating a method 600 for training an in-context machine learning model to predict target values on tabular data, in accordance with an example embodiment. At operation 602, the tabular data is accessed. The tabular data comprises one or more tables, each table comprising a plurality of columns, with at least one column being a target column for a variable to be predicted and at least one column being a feature column containing values used to predict the variable. The tabular data may be divided into training data, which contains values for both the feature columns and the target columns, and test data, which contains values only for the feature columns.

At operation 604, a sequence of feature values and target values is extracted from the tabular data. This sequence may include values from both the training data and the test data.

At operation 606, the in-context machine learning model is auto-regressively trained by passing the sequence to the in-context machine learning model. Auto-regressively in this context means that predictions for any particular target value made by the in-context machine learning model during training are based on all feature values and target values earlier in the sequence.

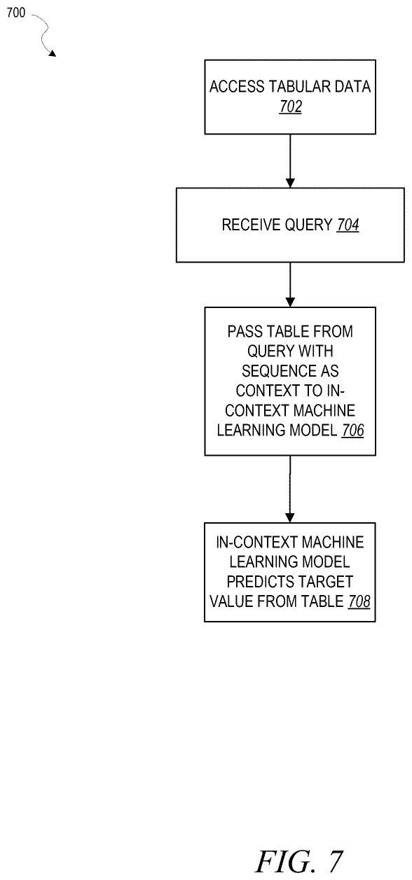

FIG. 7 is a flow diagram illustrating a method 700 for making predictions of target values in tabular data, in accordance with an example embodiment. At operation 702, tabular data is accessed. The tabular data comprises one or more tables, each table comprising a plurality of columns, with at least one column being a target column for a variable to be predicted and at least one column being a feature column containing values used to predict the variable. The tabular data may be divided into training data, which contains values for both the feature columns and the target columns, and test data, which contains values only for the feature columns.

At operation 704, a query is received. The query includes a table having a feature value but missing a target value. At operation 706, the table is passed to an in-context machine learning model with the sequence passed as context for the query. At operation 708, the in-context machine learning model auto-regressively predicts a target value for the table.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: accessing tabular data, the tabular data comprising one or more tables, each table comprising a plurality of columns, at least one column being a target column for a variable to be predicted and at least one column being a feature column containing values used to predict the variable; extracting a sequence of feature values and target values from the tabular data; training an in-context machine learning model auto-regressively by passing the sequence of feature values and target values to the in-context machine learning model such that predictions for any particular target value made by the in-context machine learning model are based on all feature values and target values earlier in the sequence; and using the trained in-context machine learning model to predict target values for queries containing feature values but not target values.

In Example 2, the subject matter of Example 1 includes, wherein the tabular data is synthetically generated using probabilistic modeling and data augmentation techniques.

In Example 3, the subject matter of Example 2 includes, wherein the tabular data includes both training data, comprising feature values and target values, and test data, comprising only feature values and no target values, and wherein the sequence includes values from both the training data and the test data.

In Example 4, the subject matter of Examples 1-3 includes, wherein the in-context machine learning model is a structured state space model.

In Example 5, the subject matter of Examples 1-4 includes, wherein the in-context machine learning model is a hybrid of a structured state space model and a transformer model.

In Example 6, the subject matter of Examples 2-5 includes, wherein the in-context machine learning model is a decoder transformer model with a causal attention mask.

In Example 7, the subject matter of Examples 1-6 includes, wherein the operations further comprise: at inference-time, feeding a query including at least one feature value into the in-context machine learning model, along with feeding the sequence to the in-context machine learning model as context for the query.

Example 8 is a method comprising: accessing tabular data, the tabular data comprising one or more tables, each table comprising a plurality of columns, at least one column being a target column for a variable to be predicted and at least one column being a feature column containing values used to predict the variable; extracting a sequence of feature values and target values from the tabular data; training an in-context machine learning model auto-regressively by passing the sequence of feature values and target values to the in-context machine learning model such that predictions for any particular target value made by the in-context machine learning model are based on all feature values and target values earlier in the sequence; and using the trained in-context machine learning model to predict target values for queries containing feature values but not target values.

In Example 9, the subject matter of Example 8 includes, wherein the tabular data is synthetically generated using probabilistic modeling and data augmentation techniques.

In Example 10, the subject matter of Example 9 includes, wherein the tabular data includes both training data, comprising feature values and target values, and test data, comprising only feature values and no target values, and wherein the sequence includes values from both the training data and the test data.

In Example 11, the subject matter of Examples 8-10 includes, wherein the in-context machine learning model is a structured state space model.

In Example 12, the subject matter of Examples 8-11 includes, wherein the in-context machine learning model is a hybrid of a structured state space model and a transformer model.

In Example 13, the subject matter of Examples 9-12 includes, wherein the in-context machine learning model is a decoder transformer model with a causal attention mask.

In Example 14, the subject matter of Examples 8-13 includes, at inference-time, feeding a query including at least one feature value into the in-context machine learning model, along with feeding the sequence to the in-context machine learning model as context for the query.

Example 15 is a non-transitory machine-readable medium storing instructions which, when executed by one or more processors, cause the one or more processors to perform operations comprising: accessing tabular data, the tabular data comprising one or more tables, each table comprising a plurality of columns, at least one column being a target column for a variable to be predicted and at least one column being a feature column containing values used to predict the variable; extracting a sequence of feature values and target values from the tabular data; training an in-context machine learning model auto-regressively by passing the sequence of feature values and target values to the in-context machine learning model such that predictions for any particular target value made by the in-context machine learning model are based on all feature values and target values earlier in the sequence; and using the trained in-context machine learning model to predict target values for queries containing feature values but not target values.

In Example 16, the subject matter of Example 15 includes, wherein the tabular data is synthetically generated using probabilistic modeling and data augmentation techniques.

In Example 17, the subject matter of Example 16 includes, wherein the tabular data includes both training data, comprising feature values and target values, and test data, comprising only feature values and no target values, and wherein the sequence includes values from both the training data and the test data.

In Example 18, the subject matter of Examples 15-17 includes, wherein the in-context machine learning model is a structured state space model.

In Example 19, the subject matter of Examples 15-18 includes, wherein the in-context machine learning model is a hybrid of a structured state space model and a transformer model.

In Example 20, the subject matter of Examples 15-19 includes, wherein the in-context machine learning model is a decoder transformer model with a causal attention mask.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

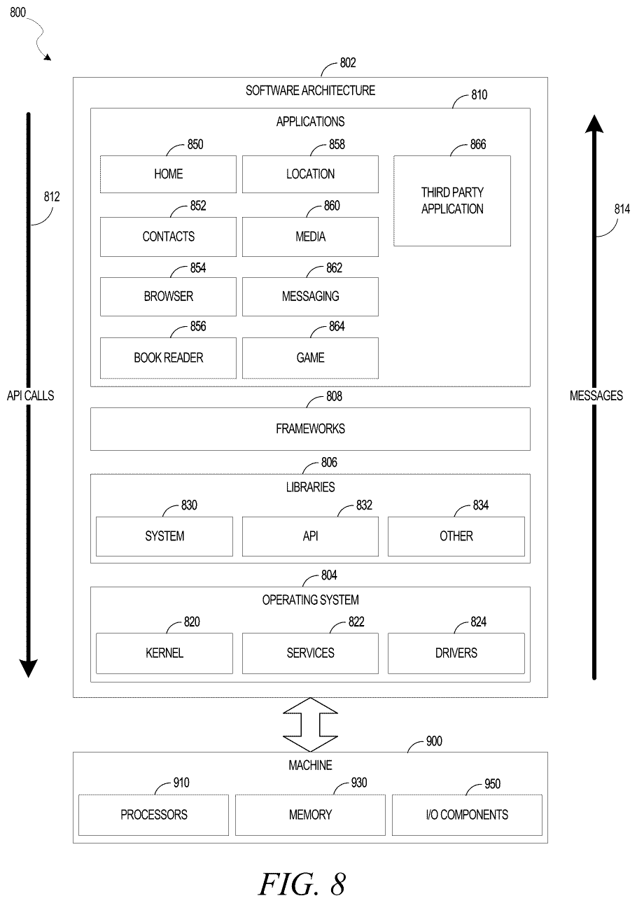

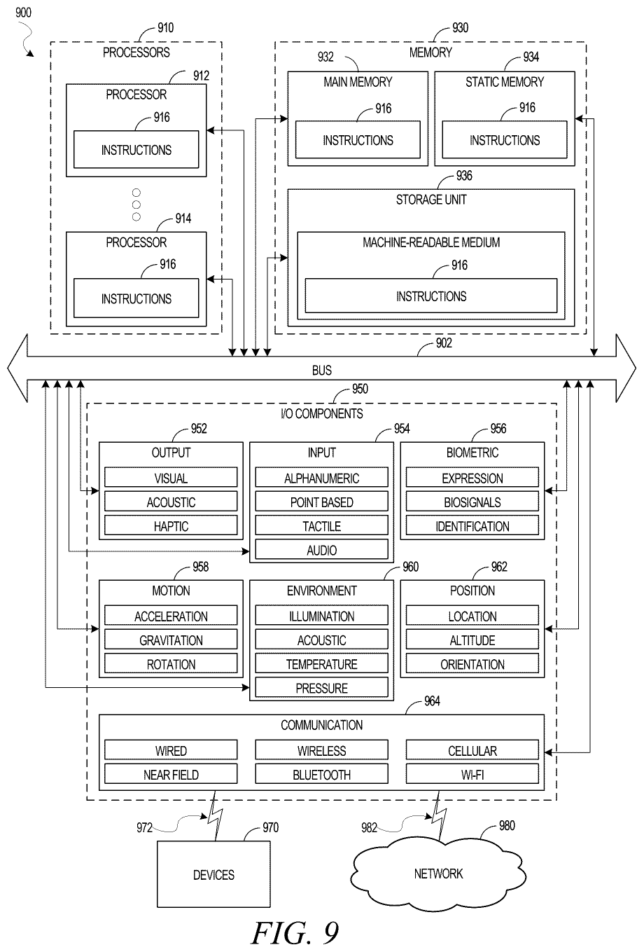

FIG. 8 is a block diagram 800 illustrating a software architecture 802, which can be installed on any one or more of the devices described above. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionalities. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [JPEG or JPG], or Portable Network Graphics [PNG]), graphics libraries (e.g., an OpenGL framework used to render in two dimensions [2D] and three dimensions [3D] in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit [SDK] by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 and send messages 814 to facilitate functionality described herein.

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the methods 600, 700 of FIGS. 6 and 7, respectively. Additionally, or alternatively, the instructions 916 may implement FIGS. 1-7 and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a central processing unit [CPU], a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions 916 contemporaneously. Although FIG. 9 shows multiple processors 910, the machine 900 may include a single processor 912 with a single core, a single processor 912 with multiple cores (e.g., a multi-core processor 912), multiple processors 912, 914 with a single core, multiple processors 912, 914 with multiple cores, or any combination thereof.

The memory 930 may include a main memory 932, a static memory 934, and a storage unit 936, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System [GPS] receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., coupled via a USB).

Moreover, the communication components 964 may detect identifiers or include components operable to detect identifiers. For example, the communication components 964 may include radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

The various memories (e.g., 930, 932, 934, and/or memory of the processor[s] 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
accessing tabular data, the tabular data comprising one or more tables, each table comprising a plurality of columns, at least one column being a target column for a variable to be predicted and at least one column being a feature column containing values used to predict the variable;
extracting a sequence of feature values and target values from the tabular data;
training an in-context machine learning model auto-regressively by passing the sequence of feature values and target values to the in-context machine learning model such that predictions for any particular target value made by the in-context machine learning model are based on all feature values and target values earlier in the sequence; and
using the trained in-context machine learning model to predict target values for queries containing feature values but not target values.

2. The system of claim 1, wherein the tabular data is synthetically generated using probabilistic modeling and data augmentation techniques.

3. The system of claim 2, wherein the tabular data includes both training data, comprising feature values and target values, and test data, comprising only feature values and no target values, and wherein the sequence includes values from both the training data and the test data.

4. The system of claim 1, wherein the in-context machine learning model is a structured state space model.

5. The system of claim 1, wherein the in-context machine learning model is a hybrid of a structured state space model and a transformer model.

6. The system of claim 2, wherein the in-context machine learning model is a decoder transformer model with a causal attention mask.

7. The system of claim 1, wherein the operations further comprise:
at inference-time, feeding a query including at least one feature value into the in-context machine learning model, along with feeding the sequence to the in-context machine learning model as context for the query.

8. A method comprising:
accessing tabular data, the tabular data comprising one or more tables, each table comprising a plurality of columns, at least one column being a target column for a variable to be predicted and at least one column being a feature column containing values used to predict the variable;
extracting a sequence of feature values and target values from the tabular data;
training an in-context machine learning model auto-regressively by passing the sequence of feature values and target values to the in-context machine learning model such that predictions for any particular target value made by the in-context machine learning model are based on all feature values and target values earlier in the sequence; and
using the trained in-context machine learning model to predict target values for queries containing feature values but not target values.

9. The method of claim 8, wherein the tabular data is synthetically generated using probabilistic modeling and data augmentation techniques.

10. The method of claim 9, wherein the tabular data includes both training data, comprising feature values and target values, and test data, comprising only feature values and no target values, and wherein the sequence includes values from both the training data and the test data.

11. The method of claim 8, wherein the in-context machine learning model is a structured state space model.

12. The method of claim 8, wherein the in-context machine learning model is a hybrid of a structured state space model and a transformer model.

13. The method of claim 9, wherein the in-context machine learning model is a decoder transformer model with a causal attention mask.

14. The method of claim 8, further comprising:
at inference-time, feeding a query including at least one feature value into the in-context machine learning model, along with feeding the sequence to the in-context machine learning model as context for the query.

15. A non-transitory machine-readable medium storing instructions which, when executed by one or more processors, cause the one or more processors to perform operations comprising:
accessing tabular data, the tabular data comprising one or more tables, each table comprising a plurality of columns, at least one column being a target column for a variable to be predicted and at least one column being a feature column containing values used to predict the variable;
extracting a sequence of feature values and target values from the tabular data;
training an in-context machine learning model auto-regressively by passing the sequence of feature values and target values to the in-context machine learning model such that predictions for any particular target value made by the in-context machine learning model are based on all feature values and target values earlier in the sequence; and
using the trained in-context machine learning model to predict target values for queries containing feature values but not target values.

16. The non-transitory machine-readable medium of claim 15, wherein the tabular data is synthetically generated using probabilistic modeling and data augmentation techniques.

17. The non-transitory machine-readable medium of claim 16, wherein the tabular data includes both training data, comprising feature values and target values, and test data, comprising only feature values and no target values, and wherein the sequence includes values from both the training data and the test data.

18. The non-transitory machine-readable medium of claim 15, wherein the in-context machine learning model is a structured state space model.

19. The non-transitory machine-readable medium of claim 15, wherein the in-context machine learning model is a hybrid of a structured state space model and a transformer model.

20. The non-transitory machine-readable medium of claim 15, wherein the in-context machine learning model is a decoder transformer model with a causal attention mask.
